(19) United States
(12) Patent Application Publication
(10) Pub. No.: US 2015/0339670 A1
(43) Pub. Date: Nov. 26, 2015

(54) SYSTEM AND METHOD FOR AUTHENTICATING A TRANSACTION OVER A DATA NETWORK

(71) Applicants: Nir SHAKED, (US); Yariv MAROELY, (US)

(72) Inventors: Nir Shaked, Tel Aviv (IL); Yariv Maroely, Tel Aviv (IL)

(21) Appl. No.: 14/412,658

(22) PCT Filed: Jul. 3, 2013
(86) PCT No.: PCT/IL2013/050566

§ 371 Date: Jan. 2, 2015

(30) Foreign Application Priority Data
Jul. 5, 2012 (IL) 220802

(51) Int. Cl. G06Q 20/40; A63F 13/792; G06Q 20/38

(52) U.S. Cl. CPC G06Q 20/4014; G06Q 20/385; A63F 13/792

(57) ABSTRACT

A method for authenticating a transaction between an initiator device and a transactor device over a data network, according to which a transaction request is submitted to the transactor device over the data network and an initiator determined one time parameter (OTP) is generated, based on parameters that are associated with the transaction request and with initiator activity. The initiator determined OTP is compared with a non-initiator determined OTP, both generated by means of an identical OTP engine. The transaction is denied if the initiator determined OTP and the non-initiator determined OTP are found to be different. The initiator activity is interfacing with a puzzle that is randomly selected and displayed on the initiator device, where the OTP engine generates an OTP as a function of parameters of the transaction request and of a puzzle result associated with the puzzle transmitted to the initiator device.

### FIELD OF THE INVENTION

The present invention relates to the field of user authentication. More particularly, the invention relates to a system and method for performing a secure transaction over a data network.

### BACKGROUND OF THE INVENTION

As a result of a recent increase in online transactions, there has been a corresponding increase in online fraud. Sensitive user information, such as a username, an account number, and a password, is liable to be intercepted while in transit from a user device interfaceable with a data network to a server of a Point of Sale (POS), or even at the POS server.

Some users are subjected to a phishing attack whereby a user is tricked into providing sensitive information to a malicious user, allowing a phisher to perform online transactions.

Online fraud is also perpetrated by means of Trojan horse malware, which, after being installed in a user computer device, allows a malicious person to gain remote access to the device and to commit data or electronic money theft.

One prior art method for ensuring a secure online transaction is by generating a captcha, or distorted, image of an identifier, and the user is then requested to verify the transaction by providing the next identifier. However, automated techniques for deciphering a captcha have been developed, and therefore the ability of achieving a secure transaction by means of a captcha is significantly limited.

U.S. Pat. No. 6,994,765 discloses a method for authenticating anonymous users while reducing the potential for middleman fraud by constructing a puzzle in response to information received from a software user.

US 2009/0282243 discloses a puzzle-based protocol that allows a token and verifier to agree on a secure symmetric key for authentication between the token and verifier. The verifier pseudorandomly selects a puzzle, and solves it to obtain a puzzle secret and a puzzle identifier. The verifier generates a verifier key based on the puzzle secret. The verifier sends the puzzle identifier and an encoded version of the verifier key to the token. The token regenerates the puzzle secret using its puzzle-generating algorithms and the puzzle identifier. The token sends an encoded response to the verifier indicating that it knows the verifier key.

US 2009/0282253 discloses a network helper that assists verifiers in executing a puzzle-based protocol for authentication of a token.

Although a user can be adequately authenticated by means of a puzzle-based protocol, a POS server cannot be authenticated, and therefore sensitive information of many users that perform online transactions with a seemingly reputable POS, becomes intercepted, leading to considerable losses.

It is an object of the present invention to provide a system and method for verifying user and POS authenticity while performing a transaction over a data network.

Other objects and advantages of the invention will become apparent as the description proceeds.

### SUMMARY OF THE INVENTION

The present invention provides a method for authenticating a transaction between an initiator device and a transactor device over a data network, comprising the steps of submitting a transaction request to said transactor device over said data network, generating an initiator determined one time parameter (OTP) based on parameters associated with said transaction request and with initiator activity, comparing said initiator determined OTP with a non-initiator determined OTP, and denying said transaction if said initiator determined OTP and said non-initiator device determined OTP are found to be different.

Preferably, the initiator activity involves interfacing with a puzzle randomly selected and displayed on the initiator device. A puzzle module for randomly selecting a puzzle is installed in the initiator device, for example by a service provider, a unique combination of different types of puzzles being installed in said puzzle module such that each of said installed puzzles has a single solution that is known to said puzzle module but unknown to the initiator.

In one aspect, a transaction request submitted by the initiator device will be denied for a predetermined number of hours if the initiator failed for three consecutive attempts to solve the puzzle within a predetermined time limit following display of the selected puzzle on the initiator device.

In one aspect, a transaction request submitted by the initiator device will be denied for a predetermined number of hours if the initiator determined OTP and the non-initiator determined OTP are found to be different for three consecutive attempts.

In one aspect, an identical OTP engine is installed in each of the initiator device and the transactor device. An actual puzzle result entered by the initiator is input to the transactor OTP engine to generate the transactor determined OTP.

In one aspect, an identical OTP engine is installed in each of the initiator device and an acquirer server to which the transaction request is transferred by the transactor device, said acquirer server also operable for authorizing payment to the transactor when the transaction is authenticated.

In one aspect, the following steps are performed by the acquirer server: (a) generating an identification number for each transaction, after receiving corresponding transaction parameters from the transactor device; (b) transmitting said transaction parameters in return to the initiator device for approval purposes, after receiving said identification number therefrom; (c) transmitting a puzzle to the initiator device, after said transaction parameters have been approved; (d) generating an acquirer determined OTP by means of said transaction parameters, an anticipated puzzle result of said puzzle transmitted to the initiator device, and the OTP engine; (e) comparing said acquirer determined OTP with the initiator determined OTP; and (f) transmitting a transaction approval to the transactor device after the acquirer determined OTP is found to match the initiator determined OTP.

The present invention is also directed to a system for authenticating a transaction over a data network, comprising an initiator device and a transactor device which are interfaceable with a common data network, wherein an OTP engine is installed in each of said initiator device and a non-initiator device and is operable to generate an OTP as a function of parameters of a transaction request submittable by said initiator device to said transactor device and of additional initiator activity performable by said initiator device, wherein said system is operable to compare an initiator determined OTP with a non-initiator determined OTP and to deny said transaction if said initiator determined OTP and said non-initiator determined OTP are found to be different.

In one aspect, the non-initiator device is an acquirer server which is interfaceable with the common data network, for authorizing or denying the transaction request and for transferring payment to the transactor when the transaction request is authorized.

In one aspect, the non-initiator device is a transactor device.

The present invention provides at least the following advantages:

1. A transaction is simply, accurately and reliably authenticated by means of an anticipated OTP, which is compared with an initiator determined OTP.

2. The OTP is a function of parameters of a transaction request submitted by the initiator device to the transactor device.

3. Means for authenticating not only the initiator, but also the transactor.

4. Determining that the initiator is a human and not a machine since only a human is able to solve the puzzle within the predetermined time limit.

5. The ability to authenticate a plurality of transactions initiated by the same or different users simultaneously, while being able to differentiate between each transaction by means of a generated identification number.

### BRIEF DESCRIPTION OF THE DRAWINGS

In the drawings:

FIG. 1 is a flow chart of a method for authenticating a transaction over a data network, according to one embodiment of the present invention;

FIGS. 2a-2c are schematic illustrations of a system for authenticating a transaction over a data network, according to different embodiments of the present invention;

FIG. 3 is a schematic illustration of an OTP engine usable in conjunction with the system of any of FIGS. 2a-c; and

FIG. 4 is a flow chart of a method for authenticating a transaction over a data network, according to another embodiment of the present invention.

### DETAILED DESCRIPTION OF PREFERRED EMBODIMENTS

Many prior art methods have been developed for authenticating a user who submitted a request for making an online purchase, or for performing any other online transaction, from a trusted POS. In reality, however, just as the POS is suspect of the purchaser as having acquired sensitive information of the user who submitted a purchase request, likewise the user is suspect of the POS as not being a bona fide enterprise that will receive payment for a product or service that will not be delivered. The applicant is unaware of any prior art method for authenticating the POS.

The present invention is a unique system and method for verifying user and transactor authenticity while performing a transaction over a data network, both being authenticated when a one time parameter (OTP), which is common to both a user device and a transactor device, is generated.

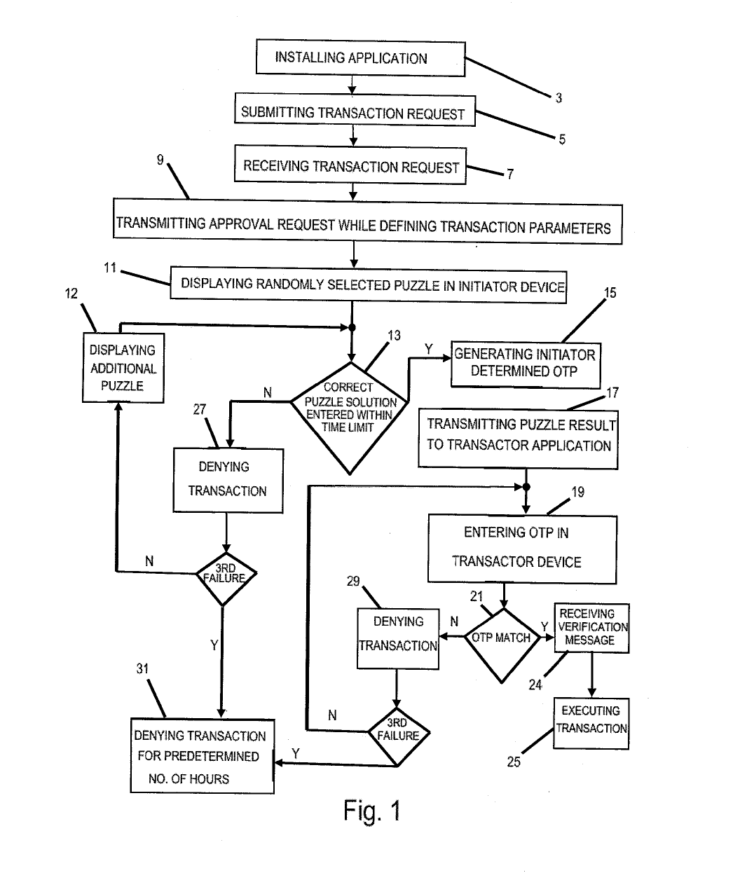

FIG. 1 illustrates a method for authenticating a transaction between an initiator and a transactor over a data network, according to one embodiment of the present invention. As referred to herein, an “initiator” is one who has initiated a transaction over the data network, such as a purchase, a money transfer or a gift, and the “transactor” is the second party of the transaction, generally one who executes the transaction.

In order to authenticate a transaction, a dedicated application has to be first installed in step 3 in both the initiator device and in the transactor device, for example at the technical support center of the service provider. As referred to herein, the “service provider” is an entity that provides the dedication application to initiator devices and to transactor devices upon demand, as well as a sufficient number of puzzles to an initiator device in order to carry out the method of the invention, as will be described hereinafter. The application includes a module for selecting a puzzle, i.e. a logical game, for verifying that the transaction request is initiated by a human, and an engine module for generating the OTP. Upon installation of the application in the initiator device, the initiator is associated with identifiable data of corresponding identification means, e.g. a personal identification number (PIN) code, biometric data, a token, and means related to a public key infrastructure (PKI) such as a private key, which has to be entered prior to accessing the application. The initiator also receives a predetermined number of puzzles, e.g. five, which are installed in the puzzle module. Each puzzle has a unique identifier and a single solution that is known to the puzzle module. Each initiator device generally has a unique combination of puzzles since the puzzle types that are installed in the given initiator device are randomly selected.

After the initiator attempts to access the application in step 5 in order to submit a transaction request, the initiator is requested to enter the associated identifiable data by means of the initiator device. For authentication and billing purposes, the initiator may also have to enter an authorization code which is received upon installation of the application. An updated list of authorization codes may be transmitted to each transactor device after a new authorization code is issued, or alternatively, the transactor device communicates with a service provider server. The initiator is allowed to access the application only after the authorization code is approved, such as by receiving an approval notice from the transactor device.

The initiator submits a desired transaction request, including type of transaction, item to be transacted, transactor identifier, sum of transaction, and type of payment means for the transaction. The transaction request is generally submitted after receiving the approval notice from the transactor device, but may be submitted when the identifiable data or the authorization code is entered. The transactor device receives in step 7 the transaction request which was transmitted over the data network, and in step 9 transmits to the initiator device in return an approval request defining the transaction parameters including a time stamp that is indicative of the time when the transaction request was submitted and optionally a location stamp that is indicative of the location from where the transaction request originated. Following initiator approval of the transaction parameters, one of the puzzles installed in the initiator device is randomly selected by the puzzle module in step 11 and is displayed.

The initiator has a predetermined time limit, following display of the selected puzzle, within which the correct solution has to be entered. If the initiator entered the correct solution within the predetermined time limit, as determined by the puzzle module in step 13, the initiator application generates an OTP in step 15 based on one or more transaction parameters and on the puzzle result. The puzzle result may be an input indicative that the puzzle was correctly solved, or alternatively, may be indicative of the puzzle identifier. The puzzle result is then transmitted by the initiator application to the transactor application in step 17, whereby to generate and store the OTP. The initiator identification is generally known by means of the transaction parameters, but also may be known as a result of the puzzle result.

The generated OTP is displayed on the initiator device and is subsequently entered in the transactor device in step 19 as well, so as to reassure the initiator that the transactor device is trusted. If the initiator is located proximate to the transactor device, for example when the transactor device is a POS device, the initiator simply enters the OTP into the transactor device, whereupon the entered OTP is compared with the stored OTP by the transactor application in step 21. The initiator and transactor are authenticated when the entered OTP and stored OTP match, enabling execution of the transaction to proceed in step 25.

If the initiator is located remotely from the transactor device, the initiator is requested to submit an encrypted OTP to the transactor device via the data network. After the initiator-transmitted OTP is compared with the stored OTP and found to be matching, the initiator device may receive a message in step 25 from the transactor device that verifies the generated unencrypted OTP, indicating to the initiator that the transactor device is to be trusted since (1) the transactor device that transmitted the verification message is the same device to which the initiator device submitted the transaction request, (2) identical engines were used to generate the same OTP as the initiator device, and (3) the transactor device is able to decipher the encrypted OTP. The verification message received by the initiator device may be generated by the transactor device, or alternatively, by the initiator application.

The transaction will be denied by the initiator application in step 27 if the correct puzzle solution was not entered within the predetermined time limit or by the transactor application is step 29 if the entered OTP and the stored OTP do not match. The initiator is permitted two additional attempts, to take into consideration human error. That is, if the correct puzzle solution was not entered into the initiator device, another puzzle will be displayed in step 12. The initiator is afforded two additional attempts to enter the correct OTP if the correct OTP was not entered into the transactor device. However, the initiator device will be denied in step 31 to submit a transaction request for a predetermined number of hours if the additional two attempts also failed. The service provider may nevertheless grant the initiator with transaction submission privileges if the initiator provides convincing explanations as to why the three attempts failed.

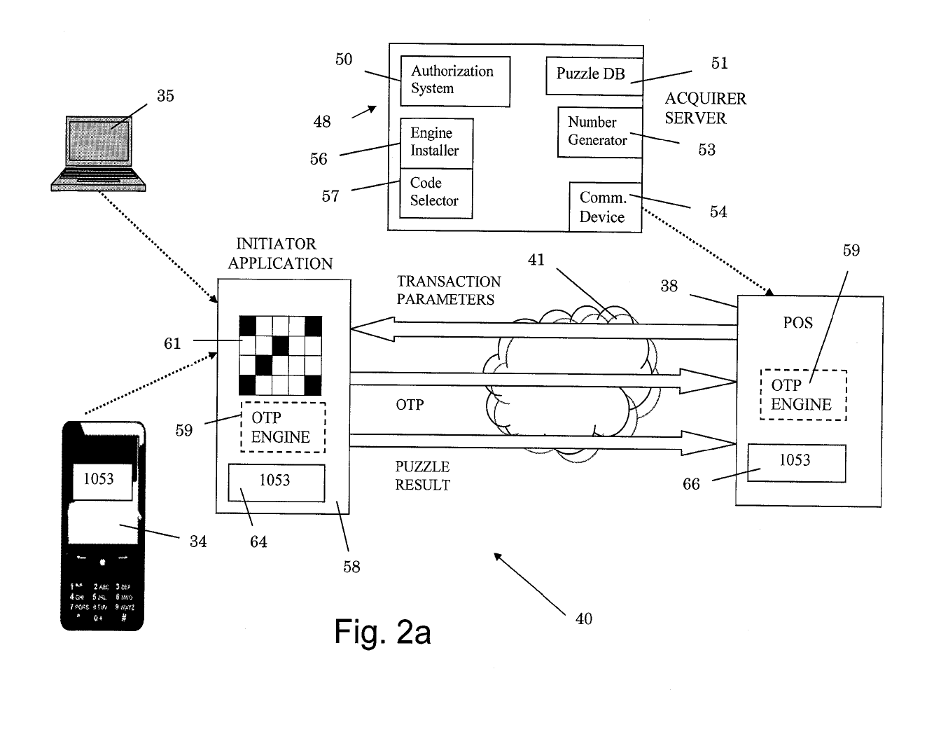

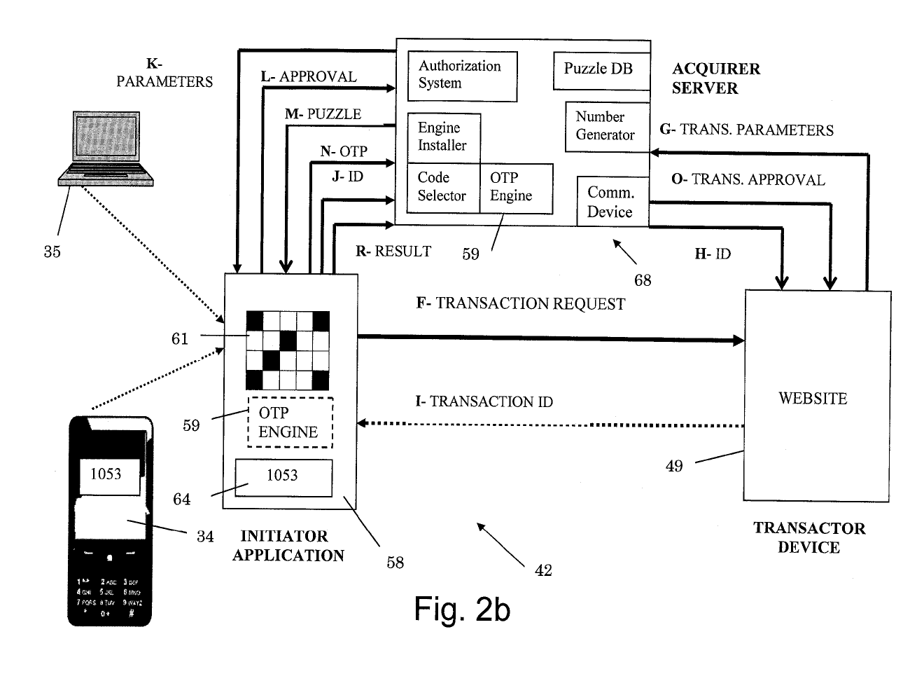

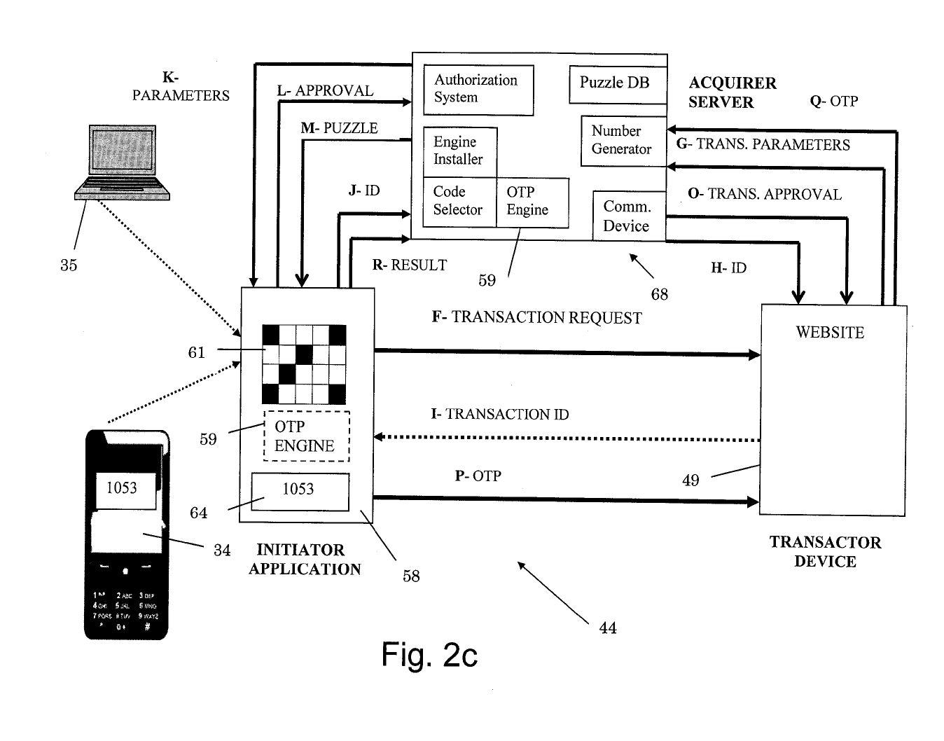

FIG. 2a schematically illustrates a system for authenticating a purchase between an initiator and a POS over a data network according to one embodiment of the present invention, and is indicated generally by numeral 40. It will be appreciated that the system is also applicable when a different type of transaction is effected and when a different type of transactor executes the transaction.

System 40 comprises an initiator device, e.g. cellular phone or digital wallet 34, or personal computer or laptop computer 35, which is interfaceable with the Internet or any other suitable data network 41, by which a request for a transaction is transmittable, a POS device 38, e.g. a server, capable of being in communication with the initiator device via data network 41, and an acquirer server 48 for authorizing or denying the requested transaction and for transferring payment to the POS merchant when the transaction request is authorized.

The acquirer is generally a credit card company for verifying that the user's credit card is valid and that the user has sufficient credit to cover the transaction; however, the invention is also applicable when the acquirer authorizes a transaction effected by other types of payment means including debit cards, electronic fund transfers, electronic commerce, direct credits, direct debits, internet banking and e-commerce payment systems, as well known to those skilled in the art.

In addition to an authorization system 50, acquirer server 48 comprises a puzzle database 51 in which is stored data associated with a plurality of puzzles or logical games for verifying that the transaction request is initiated by a human, a puzzle number generator 53, communication device 54 operable in data network 41 for transmitting the puzzle corresponding to the generated puzzle number to the initiator device and to the POS device, an OTP engine installer 56 for installing the OTP engine in both the user device and the POS device, whether online or offline, and optionally a code selector and transmitter module 57.

The initiator device has one or more input elements for entering and submitting a transaction request, including item to be transacted, POS identity, sum of transaction, and type of payment means. An initiator application 58 for interfacing with a transmitted puzzle 61 and OTP engine 59 have to be previously installed within the initiator device in order to prevent immediate denial of the transaction request. Similarly, a transaction can be consummated only when OTP engine 59 is installed in POS device 38. Puzzle 61 will be displayed on the initiator device following submission of the transaction request. The transaction request will be authorized only after the puzzle is successfully solved within a predetermined time limit and the OTP 64 generated thereafter by the initiator device matches the OTP 66 generated by the POS device.

The system may also be operable without intervention of an acquirer server, for example in conjunction with the method illustrated in FIG. 1.

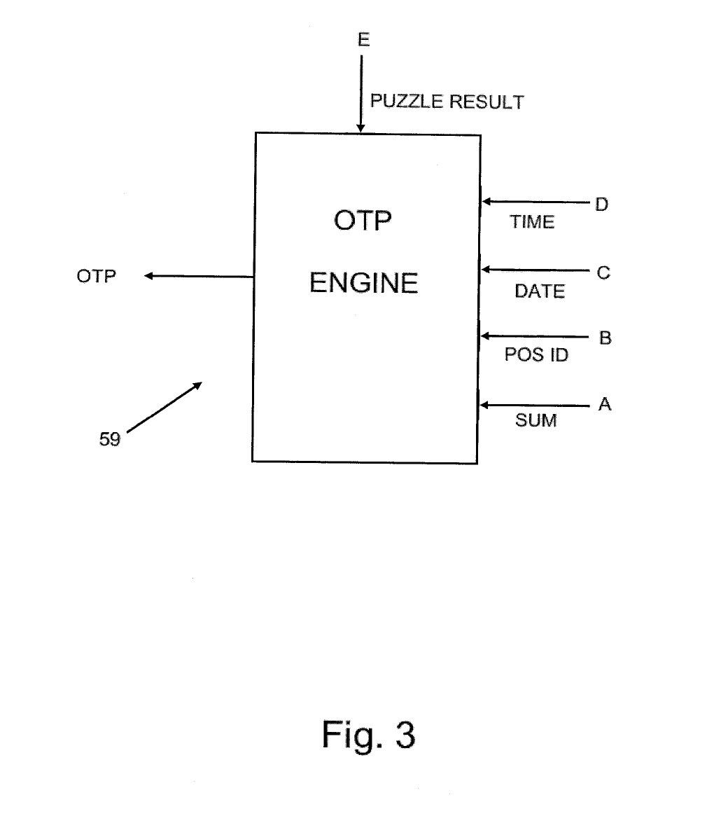

FIG. 3 schematically illustrates operation of OTP engine 59. OTP engine 59 is programmed with a code that is a function of the transaction parameters, e.g. transaction sum A, POS ID B, transaction date C, and transaction time D, as well as of puzzle result E. After the initiator solves the puzzle, the client application generates a preprogrammed output in response to the entered solution. This output is puzzle result E, and is used to generate the OTP.

In a non-limiting example, OTP engine 59 is programmed with a code for generating the OTP according to the following relation:

OTP=(2A+3B+4C+5D)*7E (Equation 1)

Thus a unique OTP based on the initiator transaction parameters and on the solution to a randomly selected puzzle will be generated. Since the same code is programmed in the engine of both the initiator device and the POS device, a correct solution to the puzzle will trigger an authorization signal to be transmitted from the acquirer server to the POS device, permitting the transaction to be consummated.

The installation of the OTP engine in the POS server, or in any other transactor device, and the programming of an acquirer selected code in the OTP engine provide an objective indication to the user that the POS is trusted by the acquirer, thereby increasing the user's confidence in the authenticity of the POS and in the likelihood of benefiting from the transaction to be performed.

As the OTP engine programmed with the same code is installed in other user devices and POS devices, many transactions would be subject to fraudulent activity if a malicious person were to gain access to sensitive user information. However, due to the limitation that the puzzle has to be solved within a predetermined period of time, e.g. 10 seconds, a malicious person who is not familiar with the operation of the puzzle will invariably be delayed while solving the puzzle and the transaction request will therefore be denied.

Another cause of transaction request denial is that a plurality of computer initiated transaction requests without human intervention are simultaneously made to different points of sale after the malicious person gained access to the sensitive initiator information. Since only a human user having characteristic perception and analytical ability is able to solve the puzzle which is based on a challenge-response test, the likelihood that a computer initiated puzzle result will be correct is very low, thereby ensuring transaction request denial.

As a further deterrent to fraudulent activity, the acquirer server may be equipped with a code selector module, which is adapted to randomly change one or more mathematical operators of the code with which OTP engine 59 is programmed, or alternatively, to randomly change one or more terms of the code. For example, three operators in the code set forth in Equation 1 may be changed to provide the following relation:

OPT=(2A−3B+4C−5D)/7E (Equation 2)

The code may be changed by a hash function, or by any other means well known to those skilled in the art, to prevent implementation of spyware or of reverse engineering methods for revealing the code programmed in the OTP engine.

FIG. 2b schematically illustrates a system 42 for authenticating a purchase or any other type of transaction between an initiator and a transactor over a data network according to another embodiment of the present invention. In this embodiment, the transactor device is a server 49 and acquirer server 68 comprises OTP engine 59 for generating the OTP which is compared with the initiator determined OTP.

After initiator device 34 transmits transaction request signal F to transactor device server 49 while browsing the website associated with the latter via the data network, transactor device 49 transmits signal G provided with the corresponding transaction parameters to the acquirer server 68 and receives in return a signal H which is provided with a transaction ID. As initiator device 34 is in data communication with transactor device 49, initiator device 34 receives the transaction ID from transactor device 49 via signal I. The initiator then activates the application and enters the received transaction ID, the entered transaction ID being transmitted via signal J to acquirer server 68 as additional means for authenticating the transaction.

The transmission of the transaction ID from acquirer server 68 to transactor device 49 provides an objective indication to the initiator that the transactor is trusted by the acquirer, thereby increasing the initiator's confidence in the authenticity of the transactor and in the likelihood of benefiting from the transaction to be performed.

Acquirer server 68, after verifying the transmitted transaction ID, transmits the transaction parameters associated with the transaction ID via signal K to initiator device 34. The initiator approves the transaction via signal L and then receives a puzzle 61 from acquirer server 68 via signal M. If the initiator entered the correct solution to the received puzzle within the predetermined time limit, initiator application 58 generates an OTP. Initiator application 58 then transmits the generated OTP via signal N, which may be in the form of an automatically generated encrypted message and alternatively accompanied by puzzle result signal R, to acquirer server 68. Acquirer server 68 generates an acquirer determined OTP by means of the transaction parameters received in signal G, the anticipated puzzle result of the puzzle transmitted to initiator application 58 via signal M, and OTP engine 59. Acquirer server 68 compares the acquirer determined OTP with the initiator determined OTP, and if found to be matching, transmits an approval for the transaction via signal O to transactor device 49, so as to complete the transaction process.

FIG. 2c schematically illustrates a system 44, which is identical to system 42 of FIG. 2b, with the exception that the initiator determined OTP is transmitted from initiator device 34 to transactor device 49 via signal P, whereupon transactor device 49 transfers the initiator determined OTP to acquirer server 68 via signal Q. Acquirer server 68 then compares the acquirer determined OTP with the initiator determined OTP.

According to an embodiment, the authorization system may reside at another server, e.g. a server used by a credit card company, and acquirer server 68 will remotely communicate with the authorization system.

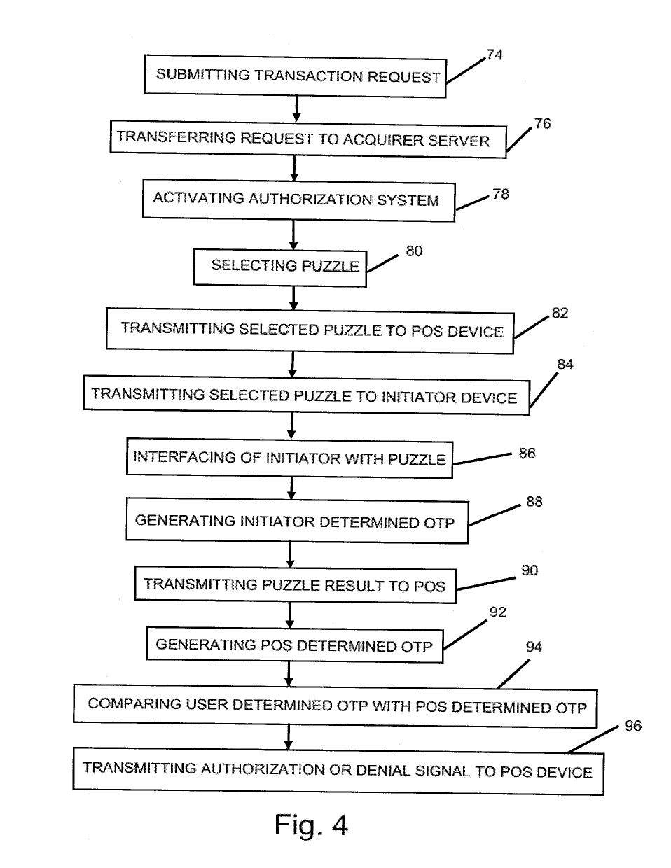

FIG. 4 illustrates another embodiment of a method for authenticating a transaction over a data network. In a non-limiting example, the transactor is described as being a POS, and it will be appreciated that this embodiment is suitable as well for any other type of transactor. A transaction request is first entered and submitted to a POS device via a data network in step 74 by means of an initiator device. The POS device then transfers this request in step 76 to an acquirer server via the data network for purposes of authorization. In response to receiving the transaction request, the acquirer server activates its authorization system in step 78 and randomly selects a puzzle number from its puzzle database in step 80. The acquirer server then transmits the selected puzzle in step 82 to the POS device while being temporarily stored in an OTP engine buffer of the POS device so that a POS determined OTP will be able to be generated.

After the selected puzzle is transmitted to the initiator device in step 84, whether by the POS device or by the acquirer server simultaneously with the transmission of the puzzle to the POS device, and displayed thereon, the initiator interfaces with the displayed puzzle. The initiator attempts to solve the puzzle in step 86 within the predetermined time limit following display of the puzzle. The initiator OTP engine is configured to output a default puzzle result if the initiator fails to enter any solution within the predetermined time limit. The initiator device then generates an initiator determined OTP in step 88 based on the puzzle result and on the transaction parameters. The initiator determined OTP is transmitted to the POS device, whereupon it is transferred to the acquirer server. The transaction will be denied by the acquirer server if the initiator determined OTP is incorrect.

Following transmission of the initiator determined OTP, the puzzle result is transmitted to the POS in step 90. Puzzle result E (FIG. 3) input to the OTP engine of the POS may be the actual result solved by the initiator, or alternatively, may be a binary result provided by the acquirer server as to whether the puzzle solution entered by the initiator was correct. A POS determined OTP is then generated in step 92 in response to the puzzle result input to the POS OTP engine, together with a correction factor to take into account the difference between the puzzle result input to the initiator OTP engine and the POS OTP engine, if necessary.

The acquirer server compares the user determined OTP with the POS determined OTP in step 94 and transmits in response to the POS device in step 96 either an authorization signal or a denial signal. A denial signal will be transmitted during the occurrence of one or more of the following events: (1) the transaction parameters are found to be not worthy of being authorized, (2) the initiator determined puzzle result is different than the acquirer known puzzle result, and (3) the initiator determined OTP is different than the POS determined OTP. Following transmission of the authorization signal or of the denial signal, the OTP engine buffer of the POS device is reset.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A method for authenticating, over a data network, a transaction between an initiator device and a transactor device, comprising the steps of:
a) submitting a transaction request from said initiator device to said transactor device;
b) in response to submission of said transaction request, displaying on said initiator device a randomly selected logical game in the form of a challenge-response test for verifying that said transaction request has been submitted by a human;
c) interfacing with said logical game on said initiator device and entering a result of said logical game;
d) generating a initiator determined one time parameter (OTP) based on parameters associated with said transaction request including a transaction sum and a transaction time and with said entered logical game result;
e) comparing said initiator determined OTP with a non-initiator determined OTP; and
f) denying said transaction if said initiator determined OTP and said non-initiator determined OTP are found to be different.

2. The method according to claim 1, wherein the initiator determined OTP and the non-initiator determined OTP are generated by means of an identical OTP engine.

3. (canceled)

4. (canceled)

5. The method according to claim 1, wherein a logical game module for randomly selecting a logical game is installed in the initiator device by a service provider, a unique combination of different types of logical games being installed in said logical game module such that each of said installed logical games has a single solution that is known to said logical game module but unknown to the initiator.

6. The method according to claim 2, wherein the logical game is randomly selected by an acquirer server to which the transaction request is transferred by the transactor device, said acquirer server also operable for authorizing payment to the transactor when the transaction is authenticated.

7. The method according to claim 6, wherein the acquirer server transmits the selected logical game to the transactor device, whereupon the transactor device transmits the selected logical game to the initiator device.

8. The method according to claim 6, wherein the acquirer server transmits the selected logical game to the initiator device.

9. The method according to claim 1, wherein an identical OTP engine is installed in each of the initiator device and the transactor device.

10. The method according to claim 9, wherein the initiator determined OTP is generated by the initiator OTP engine after the initiator enters the logical game result and a transactor determined OTP that is the non-initiator determined OTP is generated by the transactor OTP engine in response to the logical game result entered by the initiator.

11. The method according to claim 10, wherein an actual logical game result entered by the initiator is input to the transactor OTP engine to generate the transactor determined OTP.

12. The method according to claim 10, wherein a binary logical game result indicative of a correct or an incorrect logical game solution is input to the transactor OTP engine to generate the transactor determined OTP.

13. The method according to claim 10, wherein an acquirer server compares the initiator determined OTP with the transactor determined OTP and denies the transaction if the initiator failed to solve the logical game within a predetermined time limit following display of the selected logical game on the initiator device or if the initiator determined OTP differs from the transactor determined OTP.

14. The method according to claim 5, wherein the logical game module denies the transaction if the initiator failed to solve the logical game within a predetermined time limit following display of the selected logical game on the initiator device.

15. The method according to claim 14, wherein a logical game result correctly solved by the initiator within the predetermined time limit is transmitted by the initiator device to the transactor device, whereupon the transactor device generates and stores a transactor determined OTP that is the non-initiator determined OTP.

16. The method according to claim 15, wherein the initiator determined OTP is generated by the initiator device in response to the correctly solved logical game result and is subsequently entered into the transactor device, and the transactor device compares the entered initiator determined OTP with the stored transactor determined OTP.

17. The method according to claim 16, wherein the initiator determined OTP is personally entered by the initiator into the transactor device.

18. The method according to claim 16, wherein the initiator determined OTP is transmitted by the initiator to the transactor device.

19. The method according to claim 18, wherein the initiator determined OTP is encrypted when being transmitted to the transactor device and the initiator device subsequently receives in return a verification message indicative of the unencrypted initiator determined OTP.

20. The method according to claim 1, wherein a transaction request submitted by the initiator device will be denied for a predetermined number of hours if the initiator determined OTP and the non-initiator determined OTP are found to be different for three consecutive attempts.

21. The method according to claim 1, wherein a transaction request submitted by the initiator device will be denied for a predetermined number of hours if the initiator failed for three consecutive attempts to solve the logical game within a predetermined time limit following display of the selected logical game on the initiator device.

22. The method according to claim 2, wherein the OTP engine generates an OTP as a function of parameters of the transaction request and of the logical game result associated with the logical game which is transmitted to the initiator device, the function of parameters being programmed as a deterministic code in the OTP engine.

23. The method according to claim 2, wherein the OTP engine generates an OTP as a function of parameters of the transaction request and of the logical game result associated with the logical game which is transmitted to the initiator device, the function of parameters being programmed as a randomly changeable code in the OTP engine.

24. The method according to claim 6, wherein the acquirer server randomly changes one or more operators of the code programmed in the OTP engine.

25. The method according to claim 1, wherein the data network is selected from the group consisting of:
Internet;
NFC;
WiFi;
WiMAX;
Bluetooth;
Any point-to-point channel.

26. The method according to claim 1, wherein the data network is a cellular network.

27. (canceled)

28. The method according to claim 1, wherein the transactor device is a point of sale device.

29. The method according to claim 1, wherein the transaction is selected from the group consisting of a purchase, a money transfer, a real estate transaction, and a gift.

30. The method according to claim 6, wherein an identical OTP engine is installed in each of the initiator device and the acquirer server.

31. The method according to claim 30, further comprising the following steps which are performed by the acquirer server:
a) generating an identification number for each transaction, after receiving corresponding transaction parameters from the transactor device;
b) transmitting said transaction parameters in return to the initiator device for approval purposes, after receiving said identification number therefrom;
c) transmitting the logical game to the initiator device, after said transaction parameters have been approved;
d) generating an acquirer determined OTP that is the non-initiator determined OTP by means of said transaction parameters, an anticipated logical game result of said logical game transmitted to the initiator device, and the OTP engine;
e) comparing said acquirer determined OTP with the initiator determined OTP; and
f) transmitting a transaction approval to the transactor device after the acquirer determined OTP is found to match the initiator determined OTP.

32. The method according to claim 31, wherein the generated identification number is transmitted to the transactor device and then to the initiator device.

33. The method according to claim 31, wherein the initiator determined OTP is transmitted directly from the initiator device to the acquirer server.

34. The method according to claim 31, wherein the initiator determined OTP is transmitted to the transactor device and then to the acquirer server.

35. The method according to claim 31, wherein the transactor device is a server and the transaction request is submitted to the transactor device while the initiator is browsing a website associated with said transactor device server.

36. A system for authenticating a transaction over a data network, comprising:
a) an initiator device and a transactor device which are interfaceable with a common data network:,
b) one or more input elements provided with said initiator device, for entering a transaction request and submitting said request to said transactor device;
c) a logical game module for randomly selecting, in response to submission of said transaction request, a logical game in the form of a challenge-response test for verifying that said transaction request has been submitted by a human, a unique combination of different types of logical games being installed in said logical game module such that each of said installed logical games has a single solution that is known to said logical game module but unknown to the initiator:
d) communication apparatus for causing said selected logical game to be displayed on said initiator device; and
e) an OTP engine which is installed in each of said initiator device and a non-initiator device and is operable to generate an OTP as a function of parameters of said submitted transaction request, including a transaction sum and a transaction time, and of a result of said selected logical game entered in said initiator device,
wherein said system is operable to compare an initiator determined OTP with a non-ininiator determined OTP and to deny said transaction if said initiator determined OTP and said non-initiator determined OTP are found to be different.

37. The system according to claim 36, wherein the non-initiator device is an acquirer server which is interfaceable with the common data network, for authorizing or denying the transaction request and for transferring payment to the transactor when the transaction request is authorized.

38. The system according to claim 37, wherein the acquirer server comprises one or more of components selected from the group consisting of an authorization system, a logical game database in which is stored data associated with a plurality of logical games, a logical game number generator, a communication device operable in the data network for transmitting the logical game corresponding to the generated logical game number to the initiator device and to the transactor device, an OTP engine identical to the OTP engine installed in the initiator device, an OTP engine installer for installing the OTP engine in the initiator device, and an OTP code selector and transmitter module.

39. The method according to claim 36, wherein the non-initiator device is a transactor device and an OTP engine installer is operable for installing the OTP engine in said transactor device.
